(19) United States
(12) Patent Application Publication
(10) Pub. No.: US 2020/0189735 A1
(43) Pub. Date: Jun. 18, 2020

(54) ELECTRIC MOTOR SUPPORTED BALANCE CONTROL IN DRONES WITH ENGINE

(71) Applicant: Ali TURAN, Bursa (TR)

(72) Inventor: Ali TURAN, Bursa (TR)

(21) Appl. No.: 16/618,680

(22) PCT Filed: Oct. 12, 2017
(86) PCT No.: PCT/TR2017/000107

§ 371 Date: Dec. 2, 2019

(30) Foreign Application Priority Data
Jun. 4, 2017 (TR) 2017/08206

(51) Int. Cl. B64C 39/02; B64D 27/24

(52) U.S. Cl. CPC B64C 39/024; B64D 27/24; B64C 2201/027; B64D 2027/026; B64C 2201/044; B64C 2201/066; B64C 2201/042

(57) ABSTRACT

Balancing a drone is difficult with engines, when drones are equipped with engines to increase the flight time. However, balancing the drone can be made easy by providing the drone with an electric motor or an electric motor that involves a generator feature.

### STATE-OF-THE-ART

Drones involve electric motors.
Drones generate electricity from engine with generators, and fly using the electric motors.
   The Advantages of Drones with Electric Motors:
1. To keep the drones in balance, the speed of propellers should be adjusted according to the balance of the drones. This is very easy with electric motors.
2. Electric motors can turn at higher speeds. This gives an advantage of smaller propellers.
3. Start and stop time of electric motors are short and easy.
4. The drones can be produced with ease and cheap, with electric motors.
5. Smaller drones can be produced, with electric motors.
6. Production of drones are easier with electric motors.
   The Advantages of Drones with Electric Motors, Producing Electricity from Engines with Generators:
Flight distance of the drones are longer. Balance of the drones are controlled easily since the speed of propellers that keep the drone on air can be adjusted faster and stable.

### The Disadvantages:

The drones with electric motors have shorter flight time.
The engine of drones with electric motors, producing electricity from engines with generators occupies great space.

### Developed Invention and the Purpose:

To make the flight time of drones longer, instead of motor keeping the drone in mid-air engines are used. However, the reaction of engines to speed increase or decrease are longer. That makes balance control of a drone difficult.

To solve this problem, the invention involves electric motors to keep the balance of the drone, while using engine to keep the drone in mid-air. With this method, it aims at increasing the flight time, and make balancing process more stable and easy.

For increasing the drones' flight time, engines can be used instead motors to keep the drone in mid-air. Since they have higher revolution per time, turbine (jet) engines may also be used.

Since the response time of engines are long, the system is supported with electric motors to keep the drone in balance.

### The Three Different Structures of System are Designed:

1. The system with electric motors that involves the generators feature.
2. The system that uses generators separately than the electric motors.
3. The system that has engine, electric motors and batteries, but not charging the batteries from engines.

### FIGURES AND THEIR DESCRIPTION

FIG. 1: Drone structure which has engine and electric motor that involves the generators feature.

FIG. 2: Drone structure which has engine and electric motor that is separate than the generator.

FIG. 3: Drone structure which has engine and electric motor.

### EXPLANATION OF THE NUMBERS ON THE FIGURES

1. Propeller
2. Propeller of electric motor
3. The shaft of engine and electric motor
4. The shaft of electric motor
5. Engine
6. Speed control unit of engine
7. Fuel vault
8. Electric motor that involves the generator feature
9. Electricity generator
10. Electric motor
11. Control unit of electric motor that involves the generator feature
12. Control unit of electric motor and generator
13. Control unit of electric motor
14. Battery
15. Charging current flow direction
16. Discharging current flow direction

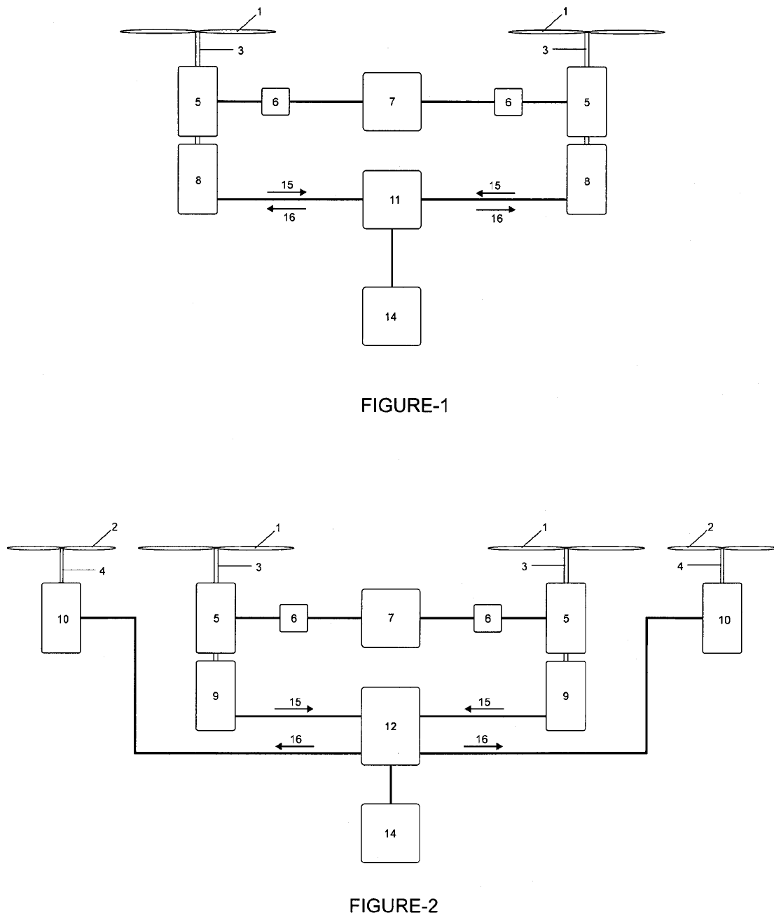

Note: The relative order of propeller (1), engine (5), electric motor that involves the generator feature (8) in FIG. 1, and the order propeller (1), engine (5), electricity generator (9) in FIG. 2 are not a strict requirement. The order can be altered. For example: propeller (1), electric motor that involves the generator feature (8), engine (5).

In the figures, group drawings are provided to show the balance. These groups can be multiples of two such as 2, . . . , 16, varying by the design of the drone.

### EXPLANATION OF THE FIGURES

FIG. 1: The drone structure which has engine and electric motor that involves the generator feature. The propeller (1) receives moving force from the shaft of engine and electric motor from engine (5) and electric motor that involves the generator feature (8). The speed of the engine (5) is controlled by speed control unit of engine (6). Fuel vault provides the engines (5) with fuel oil. The engines' (5) ignition movement is provided by using electric motor that involves the generator feature (8). Battery is charged with electric motor that involves the generator feature (8) which rotates with engines' (5) movement. While charging the current flows in the charging current flow direction (15). The stabilization of the charge is maintained by control unit of electric motor that involves the generator feature (11). In this system, the balance control of the drone is handled by the control unit of electric motor that involves the generator feature (1) with the following two methods:
1. According to the command received from the balance control system of the drone, drawing more current in the charging current flow direction (15) from the electric motor that involves the generator feature (8) using control unit of electric motor that involves the generator feature (11), decreasing the speed of the corresponding motor.
2. According to the command received from the balance control system of the drone, more current is pushed to electric motor that involves the generator feature (8) that is at the side of the drone that should be lifted, in the discharging current flow direction (16). With such technique, this balance the drone kept by lifting this side of the drone.

FIG. 2: Drone structure which has engine and electric motor that is separate than the generator. The propeller (1) is connected to engine (5) with the shaft of engine and electric motor (3). The propeller (1) is turned using engine (5). With the electricity generator (9) connected to the same system, the battery (14) is charged. The charge stabilisation is maintained by the unit of electric motor and generator (12).

In this system, electric motor (10) is used for the balance control of the drone. Electric motor (10) turns the propeller by the shaft of electric motor (4).

In this system, the balance control of the drone is handled by the control unit of electric motor and generator (12) with the following two methods:
1. According to the command received from the balance control system of the drone, drawing more current in the charging current flow direction (15) from the electric motor and generator (9) using control unit of electric motor and generator (12), decreasing the speed of the corresponding motor.
2. According to the command received from the balance control system of the drone, more current is pushed to electric motor and generator (9) that is at the side of the drone that should be lifted, in the discharging current flow direction (16). With such technique, this balance the drone kept by lifting this side of the drone.

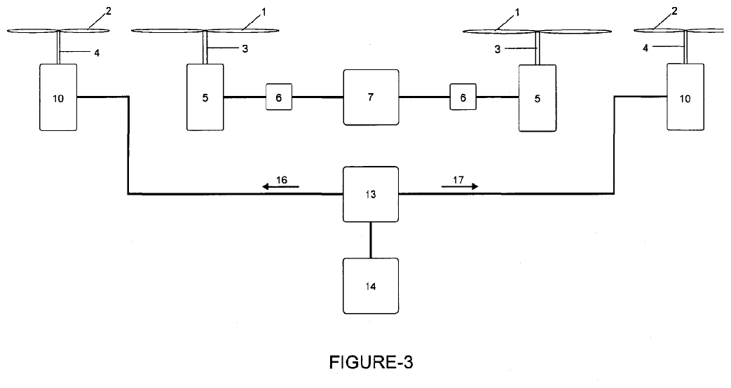

FIG. 3: The system that has engine, electric motors. The propeller (1) is connected to engine (5). The propeller (1) is turned using engine (5).

In this system, electric motor (10) is used for the balance control of the drone. Electric motor (10) turns the propeller by the shaft of electric motor (4).

In this system, the balance control of the drone is handled by the control unit of electric motor (13).

According to the command received from the balance control system of the drone, more current is pushed to electric motor (10) that is at the side of the drone that should be lifted, in the discharging current flow direction (16). With such technique, this balance the drone kept by lifting this side of the drone.

1. (canceled)

2. (canceled)

3. (canceled)

4. (canceled)

5. A method to balance a drone that contains combustion engines and electric motors that involves a generator feature, characterized in that:
providing the lifting power by only using the combustion engines for the propeller rotation to hang the drone in air; and
using only the rotational speed regulation of electric motors that involves the generator feature to balance the drone after lifting.

6. A method according to claim 1, characterized in that it comprises the methods of:
reducing the rotational speed of respective combustion engine by pulling extra current from the electric motor that involves the generator feature in the charging current flow direction, with the command received from the control unit of electric motor that involves the generator feature, in accordance to the command received from the balancing system; and/or
increasing the rotational speed of respective combustion engine, by pushing extra energy to the electric motor that involves the generator feature in the discharging current flow direction, with the command received from the control unit of electric motor that involves the generator feature, in accordance to the command received from the balancing system,
for stabilizing the rotational speed regulation of the combustion engines, with the purpose of balancing the drone.
